(19) United States
(12) Patent Application Publication
(10) Pub. No.: US 2005/0220937 A1
(43) Pub. Date: Oct. 6, 2005

(54) Novel food and the production method thereof

(75) Inventors: Keiko Ito, Kanagawa (JP); Atsuko Kayahara, Kanagawa (JP); Gaku Hibino, Kanagawa (JP); Yutaka Nishimura, Kanagawa (JP); Yasushi Nishimura, Kanagawa (JP); Hiroaki Nishiuchi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Ajinomoto Co., Inc., Tokyo (JP)

(21) Appl. No.: 11/094,359

(22) Filed: Mar. 31, 2005

(30) Foreign Application Priority Data
Mar. 31, 2004 (JP) 2004-104534

(51) Int. Cl. A23L 1/20

(52) U.S. Cl. 426/49

(57) ABSTRACT

The present invention relates to a seasoning and a processed food which are obtained by processing a fermented soybean paste-like foodstuff, and a method of the production thereof.

### CROSS-REFERENCE TO RELATED APPLICATIONS

The present application claims priority to Japanese Application No. JP 2004-104534 filed on Mar. 31, 2004, which is hereby incorporated by reference in its entirety.

### BACKGROUND OF THE INVENTION

1. Field of the Invention

The present invention provides a novel seasoning, a processed food, and a production method thereof. In the embodiments of the present invention, a fermented soybean paste-like food material produced by a bacteriostatic method is employed in place of using sodium chloride.

2. Discussion of the Background

In historical and modern Japan, many kinds of fermented soybean pastes are used in conventional fermented foods many of which are rooted in each geographic region. The fermented foods can be classified based on various aspects, however, they their broad classification is based on the raw material employed therein. Examples of these classifications include: rice fermented soybean pastes (kome miso) made from rice as a principal raw material, wheat fermented soybean pastes (mugi miso) made from wheat as a principal raw material, and bean fermented soybean pastes (mame miso) made from soybean as a principal raw material.

Further, methods for the production of a fermented soybean paste also vary significantly and include the following main steps. First, solid koji is produced by inoculating a koji mold starter with soybean, wheat, or rice as a raw material that was soaked in water, steam-cooked and cooled. The resulting solid koji is cultured at a certain temperature range (for example, 30 to 40° C.), at a certain humidity range (for example, 90 to 95% RH), and for a certain period of time (for example, 40 to 48 hrs), thereby Koji mold is allowed to grow on the surface in what is termed a “koji making step.” It is important to note that during the koji making step, koji mold produces a large quantity of catabolic enzymes such as protease, pectinase, amylase and lipase. Next, steam-cooked or roasted grain (e.g., soybean, rice, wheat and the like) and an aqueous salt solution for a bacteriostatic purpose are added to the solid koji following the koji making step, to obtain an unrefined soy of a fermented soybean paste. The fermented soybean paste is produced through fermentation and aging of this unrefined soy of fermented soybean paste for several months to several years. Because the fermented soybean paste is produced according to the method as described above, the fermented soybean paste is hydrolyzed into a state that is distinct from the original shape of the raw materials.

Conventionally, Japanese have ingested various types of fermented foods, including fermented soybean pastes, soy sauces and fermented soybeans (natto), to obtain nutrients required for health. Particularly, in recent years, dietary habits of Japanese that predominantly eat cereals and marine products (e.g., soybean, rice and fish) have attracted attention from the world over because the people of Japan enjoy the most longevity of any country in the world. However, the Western life-style now affects the dietary habits of Japan, resulting in changes from the rice diet to bread diet, from the soup of a fermented soybean paste (miso soup) to other soups. In order to magnify the consumption of the fermented soybean paste as part of a healthy diet, not only in Japan but in the world, development of foods in which a novel fermented soybean paste-like foodstuff is utilized that is suited for Westernized modern society is in high demand.

However, fermented soybean pastes contain 6 to 13% of sodium chloride. As a result, consumption of fermented soybean past has stagnated owing to the popular belief that overconsumption of fermented soybean pastes causes excessive ingestion of salt, thereby preventing the sufficient appeal of its healthy value. Further, when a large amount of fermented soybean paste is used, the food becomes so salty that the amount of the fermented soybean paste which may be added to a food is usually only 13% or less for use as a seasoning (Fifth ed. Food Composition Table, 2001, p. 418), leading to a ground for stagnation of the consumption of fermented soybean paste.

Taking this social and technical background into consideration, investigations for a production method for reducing sodium chloride content of the fermented soybean paste, such as reduced-salt fermented soybean paste or salt-free fermented soybean paste, have been conducted. Examples of these investigations include: a production method for a high-protein containing food using low-salt fermented soybean paste produced by diluting and dialyzing a fermented soybean paste (JP-A No. S58-175463), a production method for salt-free fermented soybean paste by dilution of a fermented soybean paste with water (JP-A No. S63-214154), a production method for koji in which a raw material treatment of the source for koji, i.e., water spray, steaming, cooling, and koji making are carried out in a single apparatus using a rotary pressurizing drum (JP-A No. H07-1079663), a method in which a nisin lactic acid bacterium is used in place of sodium chloride (Handbook of applied unheated sterilization of foods, Takeo Katou, p. 216).

However, the fermented soybean paste manufactured by these methods is merely intended to be used as a substitute for conventional fermented soybean paste. Other applications may include the following two typical examples. One is an invention which relates to a refreshing beverage that involves a combination of the flavor of the fermented soybean paste and the sweet taste of fruit juice (Japanese Patent No. 1947954). Another example produces a nutritious food by powderizing a fermented soybean paste alone or a fermented soybean paste mixed with other nutrient (JP-A No. 2001-346536). In this technique, the fermented soybean paste powder thus manufactured is adjusted to have the shape as a nutritional supplement through capsulation or pelletization. However, to date a method to shape salt-free fermented soybean paste that was produced by hydrolyzing a raw material thereby producing a novel processed food into the shape of cheese, bean curd, bar, or solid roux has not been proposed.

Furthermore, also in cases of use of the reduced-salt or salt-free fermented soybean paste in conventional seasoning applications, a specific method in practice as use in seasoning applications has not been investigated based on the idea of merely intending to provide a substitute for the fermented soybean paste. Although sodium chloride is referred to as affecting hydrolysis of raw materials through inhibition of the reaction of various enzymes and the like, the fermented soybean paste-like foodstuff produced by keeping the bacteriostatic state without using sodium chloride includes different compositions from those in conventional fermented soybean paste.

Therefore, utilization methods and effects of a foodstuff obtained thereby are greatly different from uses in seasoning applications. For example, an idea to utilize a fermented product prepared by adding koji mold to boiled bean or steamed bean for a food is disclosed (WO 98/5262). In connection with this method, an idea to utilize a material prepared by keeping the fermentation temperature of 50 to 70° C., preferably 60° C., and allowing aging in this state for approximately 6 to 12 hrs in the fermentation and maturation step for a food is disclosed. Because optimal temperature of enzymatic activity varies depending on the kinds thereof, it is difficult to predict the degree of hydrolysis of the raw material. However, the hydrolysis ratio of the raw material is estimated to be not very high because the fermentation temperature of usual fermented soybean paste is approximately 30° C., and the hydrolysis period is from 1 year through several years.

Moreover, a method in which gluconic acid is substituted for sodium chloride to obtain a material when koji mold is added to the raw material to allow for hydrolysis is disclosed (JP-A No. 2001-346536). In this method, addition of gluconic acid results in unique flavor and hydrolysis ratio being not that high. On the other hand, a method in which a fermented soybean paste-like material is manufactured through hydrolyzing the raw material utilizing nisin (a bacteriocin) as a bacteriostatic agent that can be substituted for sodium chloride is disclosed. In this document, it is described that “Deterioration of prepared foods such as daily dish and boxed meals, and processed foods such as dipping sauces and dressings can be effectively prevented when lactic acid fermented soybean paste is utilized.” in the chapter of “issue and possibility in the future” (Handbook of applied unheated sterilization of foods, Takeo Katou, p. 216). However, such utilization in foods is merely presented as “Issue and possibility in the future”, and specific description is not found as to how it may be utilized in effect, and effects exerted upon use. Accordingly, it is believed that the technique has not been established as a practicable one. Further, it is not described as probability of the utilization of the salt-free fermented soybean paste-like food of the invention.

### SUMMARY OF THE INVENTION

It is an object of the present invention to provide a seasoning and a processed food which is obtained by processing a fermented soybean paste-like foodstuff produced without adding sodium chloride for the bacteriostatic purpose, and a method of the production thereof. The seasoning or a processed food of the present invention exhibits strong umami taste, richness and thickness.

The present inventors elaborately investigated in order to solve the problem associated with the current state of the art as described, and consequently, conceived a method for utilizing a fermented soybean paste-like food material produced by using a bacteriostatic process being a substitute for adding sodium chloride or a gluconic acid salt in the step of said material comprising making solid koji with koji mold, and a method for producing a processed food with said material. Thus, the inventors found that the processed food produced according to such a procedure is a novel processed food which has not been present so far in terms of umami taste, richness, and thickness. The present inventors found that the processed food shaped by adding other foodstuff such as enzymes, oils and fats and gelatin to the aforementioned fermented soybean paste-like food material is a novel food which has not been present so far.

Additionally, the inventors found that when a fermented soybean paste-like food material produced using nisin as a bacteriostatic method which can be a substitute for using sodium chloride is utilized as a seasoning material, novel effects are achieved because high solubilization ratio of amino acids is provided on behalf of the absence of inhibitory effect of the protease activity exerted by sodium chloride, and hydrolysis ratio of carbohydrates and the like is liable to be reduced because of short aging period. Accordingly, the present invention provides, inter alia, the embodiments described below:

(1) A production method for a food obtainable by mixing a fermented soybean paste-like food material with a food material other than said fermented soybean paste-like food material, wherein said fermented soybean paste-like food material obtained by a method comprising (a) making a solid koji from a plant raw material and koji mold, (b) making un unrefined soy by adding steam-cooked or roasted raw plant material to said solid koji, and (c) hydrolyzing said unrefined soy in the absence of sodium chloride or gluconic acid salt for a bacteriostatic purpose.

(2) The method according to (1), wherein said plant raw material comprises at least one grain selected from the group consisting of soybean, rice, and wheat.

(3) The method according to (1) or (2), wherein said koji making and/or hydrolyzing the unrefined soy is conducted in the presence of a culture broth of a bacteriocin (e.g., nisin) producing lactic acid bacterium or a supernatant thereof.

(4) The method according to (1) or (2), wherein said koji making and/or hydrolyzing the unrefined soy is conducted in an aseptic and airtight container.

(5) The method according to (1) or (2), wherein said fermented soybean paste-like food material is obtained by (a) adding koji mold and a culture broth of a bacteriocin producing lactic acid bacterium or a supernatant thereof to a raw plant material comprising at least one grain selected from the group consisting of soybean, rice and wheat, (b) making koji in a koji-making machine in which the outside air is shut out except for the time period of “TEIRE”-treatment, while supplying sterilized air continuously or intermittently, (c) mixing thus resulting koji with a culture broth of a bacteriocin producing lactic acid bacterium or a supernatant thereof, and further mixing with previously steam-cooked or roasted composition comprising at least one grain selected from the group consisting of soybean, rice, and wheat in an amount of 0.01 to 50 times by weight of the resulting koji as needed, (d) forming the unrefined soy by making the paste form of the mixture, and (e) hydrolyzing the unrefined soy essentially in the absence of sodium chloride.

(6) The method according to any one of (1) to (5), wherein said food is a seasoning, a soup, a retorted food or a confectionery.

(7) The method according to (6), wherein said seasoning is a chili seasoning, a soy sauce, a stock, a sauce, a tomato product, a dressing or a roux.

(8) A production method for a processed food comprising shaping the food obtained by the method according to any one of (1) to (7).

(9) The method according to (8), wherein said processed food is a bar-shaped food, a solid roux type food, a baked confectionery or a wet type food containing 10 to 95% by weight of moisture.

(10) The method according to (8) or (9), wherein said shaping step is by an enzymatic process.

(11) The method according to (8) or (9), wherein said shaping step is by baking.

(12) The method according to (8) or (9), wherein said shaping step is by heating and cooling with fat or oil.

(13) The method according to (8) or (9), wherein said shaping step is by heating and cooling with a gelatin and/or polysaccharide.

(14) A food obtained by the method according to any one of (1) to (13).

The above objects highlight certain aspects of the invention. Additional objects, aspects and embodiments of the invention are found in the following detailed description of the invention.

### DETAILED DESCRIPTION OF THE INVENTION

Unless specifically defined, all technical and scientific terms used herein have the same meaning as commonly understood by a skilled artisan in enzymology, biochemistry, cellular biology, molecular biology, and the food sciences.

All methods and materials similar or equivalent to those described herein can be used in the practice or testing of the present invention, with suitable methods and materials being described herein. All publications, patent applications, patents, and other references mentioned herein are incorporated by reference in their entirety. In case of conflict, the present specification, including definitions, will control. Further, the materials, methods, and examples are illustrative only and are not intended to be limiting, unless otherwise specified.

An advantage of the present invention is that a novel seasoning and a processed food can be provided that appeals to the sense of healthiness. An additional advantage of the novel seasoning and processed food of the present invention is that it can be used as a seasoning or a foodstuff in a larger quantity than conventional seasonings due to a lower salt content, and exhibits richness and thickness with a quality that can not be provided by any other material.

In the present invention, the fermented soybean paste-like food material is not particularly limited as long as it is a foodstuff obtained by maintaining bacteriostatic state without adding sodium chloride and/or gluconic acid salt for the bacteriostatic purpose.

Generally, in the fermentation process of a fermented soybean paste or a fermented soybean paste-like foodstuff, the amount of sodium chloride added to suppress proliferation of undesired microorganisms, i.e., for a bacteriostatic purpose, is 5 to 10% by weight per the weight of the unrefined soy in the low-salt fermented soybean paste, while it is 10% by weight or greater in traditional fermented soybean paste. Therefore, the amount of sodium chloride added in the production step of “a fermented soybean paste-like food material obtained without adding sodium chloride for the bacteriostatic purpose” according to the invention may be less than 5%, preferably less than 1%, and more preferably less than 0.1% per the weight of the unrefined soy. Thus, sodium chloride content in the resulting fermented soybean paste-like food material shall be less than 5% by weight, preferably less than 1%, and more preferably less than 0.1%. The above-recited sodium chloride concentration also defines the term “essentially in the absence of sodium chloride” as it is used herein.

In terms of sensory perception, it is desired that the material be obtained using a process for maintaining a bacteriostatic state, which is preferably at least one or more selected from the group consisting of: a process in which a culture broth of a bacteriocin producing lactic acid bacterium or a supernatant thereof is added upon production of the solid koji; a process in which a culture broth of a bacteriocin producing lactic acid bacterium or a supernatant thereof is added to a charging water added to the solid koji; and a process in which a bacteriostatic state is kept by carrying out the production of the solid koji and the hydrolysis of the unrefined soy of fermented soybean paste in an aseptic airtight container. More preferably, the bacteriostatic process includes the following 5 steps, since this method enables scaling-up to an industrial level. The “TEIRE”-treatment referred to herein means the step of periodically agitating koji for the purpose of accelerating growth of the Koji mold during the koji making.

Step 1: adding koji mold and a culture broth of a bacteriocin producing lactic acid bacterium or a supernatant thereof to a raw plant material such as soybean, rice or wheat;

Step 2: making koji in a koji-making machine in which the outside air is excluded except for the time period of “TEIRE”-treatment, while supplying sterilized air continuously or intermittently;

Step 3: mixing the resultant koji with a culture broth of a bacteriocin producing lactic acid bacterium or a supernatant thereof, and further adding previously steam-cooked or roasted one or more grain(s) selected from soybean, rice, wheat and the like in an amount of 0.01 to 50 times by weight of the resulting koji as needed;

Step 4: obtaining an unrefined soy by making the paste form of the mixture; and

Step 5: hydrolyzing the unrefined soy essentially in the absence of sodium chloride.

For sterilizing the air in step 2, a filter which can collect 99.97% or more of dust of 0.3 μm or larger, e.g., HEPA filter or the like may be used. The outlets for air of the koji making machine must be fitted with a filter for shutting out the outside air.

The culture broth of a lactic acid bacterium or a supernatant thereof preferably has, for example, the nisin activity of 20 IU/ml or higher and preferably 200 IU/ml or higher which may be added in an amount of 0.0001 to 0.2 times, preferably 0.001 to 0.1 times, and more preferably 0.01 to 0.05 times of the raw material for koji.

After putting the mixture of the raw material for koji, the culture broth of a lactic acid bacterium or a supernatant thereof and Koji mold into the koji making machine, koji making is performed at a temperature ranging from 20 to 40° C., preferably 24 to 34° C., for 17 to 62 hours, preferably for 43 to 55 hours, and more preferably for 43 to 49 hours. To this end, the inner part of the koji making machine is maintained as being free from outside air with the exception of the time period of “TEIRE”-treatment (a step of stirring the mixture in the koji making machine, for example, every 10 hours for the purpose of accelerating the growth of the Koji mold) to obtain koji.

Because the inner part of the koji making machine is exposed to the outside air upon “TEIRE”-treatment, there is a risk of contamination with undesired microorganisms. Therefore, to minimize the risk, total time period of the “TEIRE”-treatment, in other words the integrated value of the time period during which the inner part of the koji making machine is exposed to the outside air, must be as short as possible. Specifically, it is necessary to reduce the time for “TEIRE”-treatment or to reduce the number of such treatments. The time for one “TEIRE”-treatment should be less than 1.5 hours, preferably less than 30 minutes and more preferably around 15 minutes. However, it is also possible to use “TEIRE” for about 2 minutes. The usual frequency of “TEIRE”-treatment is once every 10 hours during the koji making process. However, it is also within the scope of the present invention that the frequency of “TEIRE”-treatment is once every 5-15 hours during the koji making process. Accordingly, the koji making is carried out in the state where the outside air is excluded for at least 15.5 to 61.5 hours, and preferably 16.5 to 60.5 hours.

The mixture of the resulting koji, a food material or materials, and the culture broth of a nisin lactic acid bacterium or the supernatant thereof is ground with a chopper or the like, and thus a paste form is obtained to form an unrefined soy. The unrefined soy is incubated at 20 to 50° C., preferably 20 to 45° C., and more preferably 25 to 35° C. for fermentation (aging) and hydrolyzed for 1 to 50 days, preferably 3 to 30 days, more preferably 4 to 14 days, and further preferably 4 to 9 days.

After completing aging and hydrolysis the unrefined soy is heated at 50 to 130° C. for 1 to 150 minutes. Processes for heating is not limited, but a double pipe heater, a multiple pipe heater or the like which has been used in pasteurization of fermented soybean pastes can be used. Also, a warm water bath or the like may be used.

In the present invention, the raw plant material for the solid koji that may be used include soybean, rice, wheat or the like, which has been used in traditional fermented soybean paste. Such raw material may be soaked in water, steam-cooked or roasted, as needed.

In the present invention, the culture broth of a bacteriocin producing lactic acid bacterium and a supernatant thereof that may be used are not particularly limited as long as the bacteriostatic effect can be achieved and maintained. Examples of the bacteriocin produced by lactic acid bacteria include nisin, pediocin, sakacin, nukacin and the like. Among them, nisin is preferably used in light of the wide antibacterial spectrum. When nisin is used, the kind of nisin which is produced by lactic acid bacteria may be any one of nisin A, nisin Z and analogues thereof. Higher bacteriocin activity in the culture broth of a lactic acid bacterium or a supernatant thereof for use is more preferred for preventing contamination with and proliferation of microorganisms. Thus, for example, L. lactis AJ 110212 (FERM BP-8552) and the like which highly produce nisin Z can be used. The L. lactis AJ110212 strain was deposited on Nov. 19, 2003 with National Institute of Advanced Industrial Science and Technology, Patent Microorganisms Depositary Center under the accession number of FERM BP-8552.

According to the present invention, the aseptic airtight container for use is not particularly limited as long as production of the solid koji and hydrolysis of the unrefined soy of fermented soybean paste can be aseptically conducted while maintaining a bacteriostatic state. It is desired that the aseptic airtight container having a function to supply sterilized air into the koji making machine and having a structure capable of shutting off the interior of the koji making machine from the ambient air, for example, a koji making machine of the rotary drum type is used.

In the present invention, the koji mold is not particularly limited. Particularly suited for use in the present invention are any koji mold that is used in traditional fermented soybean paste or soy sauce. For example, A. oryase and/or A. sojae can be used. It is desired that the koji mold for use can highly hydrolyze the raw material protein into amino acids and peptides, and can impart thickness, strong umami taste and richness to the resultant fermented soybean paste-like food material, but not particularly limited thereto.

In the present invention, the foodstuff mixed with the fermented soybean paste-like food material produced by the aforementioned process is not particularly limited as long as it is edible, and processible. As a matter of course, examples of the foodstuff which can be used include various types of sauces, sodium chloride, vinegar, seasonings, spices, soy sauces, tomato products, dressings, fermented soybean pastes, cereals, potatoes, starches, sugars, sweeteners, beans, nuts and seeds, vegetables, fruits, mushrooms, algae, seafoods, meats (including gelatins), eggs, dairy products, oils and fats, beverages, cooked processed foods and the like. Foods obtainable according to the present invention include seasonings, soups, retorted foods and confectioneries. In the present invention, soups include Western soups such as potage and consomme, Chinese soup such as hot-and-sour soup and Japanese soup such as miso soup. In the present invention, retorted foods include packaged foods sterilized at high temperature and under high pressure, for example, heated at 120° C. for more than 4 minutes and packaged food sterilized in hot water at 80° C. to 100° C. Some of the examples are cooked rice, curry, stew, Hamburg steak, broiled fish, powdered meat, salmon flake, boiled bean, and the like.

In the present invention, the mixing ratio of the fermented soybean paste-like food material and a food material other than the fermented soybean paste-like food material in the shaped food is not particularly limited as long as it is a ratio that enables ingestion of the fermented soybean paste-like foodstuff. The amount of the fermented soybean paste-like foodstuff to be used is preferably 1 to 99 parts by weight in light of the strength of the taste.

In the present invention, the term “seasoning” means any one which makes the taste well-balanced when it is added to various types of foods. Specifically, illustrative examples thereof include the seasonings described in Fifth ed. Food Composition Table. That is, chili seasonings such as Tobanjan (fermented broad bean paste with red pepper), seasoning sauces such as soy sauces, dried bonito base seasoning sauces, seasoning sauces for Chinese dishes, seasoning sauces for Western dishes, seasoning sauce for Japanese dishes, consomme cube, consomme liquid and granular flavorings, tomato products such as ketchup and tomato sauces, dressings, rouxes such as rouxes for curry, rouxes for hash and rouxes for stew, and the like are included. Additionally, as a matter of course, sauces for broiled fishes and sauces for roasted meats, seasoning mixes such as sauces for Chinese dishes and seasonings for fried chicken are also included in the present invention.

In the present invention, illustrative examples of the sauce include Worcestershire sauces such as Worcestershire sauce, moderately concentrated (chuno) sauces and concentrated (noukou) sauce, chili pepper sauces classified in chili seasonings, or seasoning sauces such as oyster sauce, seasoning mixes for Ma-po Dou-fu (Chinese style Tofu and minced meat) and meat sauces, tomato sauces classified in tomato products, chili sauces or white sauces, brown sauce, and the like.

The food obtained according to the present invention can be distributed in general shape. The food may be in the shape of paste as it is, or may be powderized as needed. Illustrative examples of the process for powderization include vacuum drying processes, freeze-drying processes, spray dry processes, drum drier processes, vacuum drum dryer processes, micro wave drying processes and the like. Upon this process, an excipient may be added as needed. Examples of the excipient (bulking agent) which may be added include dextrin, lactose, salts, sodium glutamate, granulated sugar, gelatin and the like.

In the invention, the processed food characterized by subjecting to shaping is not particularly limited as long as it is a food whose original shape is maintained, but may include bar-shaped foods, solid roux type foods, baked confectioneries or wet type foods containing 10 to 95% by weight of moisture and the like. The bar-shaped food may be prepared by shaping in e.g., a columnar shape, and may be either a wet type prepared by packing into a mold, or a dry type prepared by baking. Examples of the baked confectionery include cookies, biscuits, muffins, sponge cakes, rice crackers and the like. Wet type foods referred to herein mean solid or semisolid foods containing 10 to 95% by weight of moisture such as cheese, bean curd, yogurt, pudding and the like. The moisture content of the wet type foods is more preferably 30 to 85% by weight in the light of shelf life, easiness to eat and the like. Examples of the process for shaping include packing processes in a mold, hardening processes with an enzyme, hardening processes with dehydration and heating-denaturing through application of heat such as baking, steaming and the like, hardening processes with an oil or a fat, hardening processes with gelatin, a polysaccharide or a thickener, hardening processes with a coagulating agent, hardening processes with freezing, hardening processes with drying, and the like.

In the present invention, the enzyme for use upon shaping is not particularly limited as long as it enables shaping through mixing with the fermented soybean paste-like food material and the other foodstuff. For example, transglutaminase can be illustrated. Although transglutaminase is classified into calcium independent ones and calcium dependent ones, either one may be used according to the invention. Examples of the former include those derived from microorganisms such as mycobacteria, Bacillus subtilis and the like (see, e.g., JP-A No. S64-27471). Examples of the latter include those derived from guinea pig liver (see, JP-B No. H01-50382), those derived from microorganisms such as Oomycota, those derived from animals such as bovine blood, porcine blood and the like, those derived from fishes such as salmon, red sea bream and the like (see, e.g., Nobuo Seki et al., “Nippon Suisan Gakkai-shi (Fisheries Science), VOL. 56, 125-132 (1990)” and “Summary report of the lecture in The Japanese Society of Fisheries Science, meeting in spring in 1990, p.219”, those referred to as factor XIII existing in blood (13th factor) (WO93/15234), those derived from oyster, those included in minced fish used for manufacture of fish sausage and the like, and the like. In addition, any transglutaminase may be used such as those produced by gene recombination (JP-A Nos. H01-300889, H06-225775, H07-23737, European Patent Publication EP-0693556A) and the like. Origin and process for the production of the enzyme are not limited. Preferably, calcium independent one may be used in the light of functional and economical aspects for food applications. More preferably, transglutaminase derived from a microorganism (JP-A No. S64-27471) may be also used.

In the present invention, when the process for shaping is a method in which baking is conducted, baking with an oven may be performed after mixing the fermented soybean paste-like food material and a food material other than the fermented soybean paste-like food material, and the process for baking is not particularly limited. The baking temperature is not particularly limited as long as it falls within a range that allows shaping the food. Shaping can be controlled by extending the baking time period when the temperature is low. To the contrary, when the temperature is high, it can be controlled by shortening the baking time period. In general, the temperature employed in the baking step, i.e., 90 to 230° C. is preferably since ordinary baking equipment can be used. In light of the operation, the temperature of 100 to 180° C. is more preferred.

In the present invention, the oil and fat for use in the shaping is not particularly limited as long as it is hardened in the cooling process and melted and homogenous in the heating process after it is mixed with a fermented soybean paste-like food material. For example, as a matter of course, vegetable oils and fats such as hydrogenated soybean oil, animal fats such as lard and beef fat, butters, margarines, other oils and fats (including shortening) and the like may be used.

In the present invention, gelatin and polysaccharides that may be used upon shaping are not particularly limited as long as it is hardened in the cooling process and melted and homogenous in the heating process after it is mixed with a fermented soybean paste-like food material. For example, gelatins derived from cow, pig, birds or fishes as the gelatin, agar, carrageenan, alginic acid salts, starches such as potato, gums such as guar gum and xanthan gum as the polysaccharide may be used.

Because the novel food obtained according to the method of the invention is tasty, functional ingredients for health of the fermented soybean paste such as isoflavone and saponin in a large quantity can be readily ingested in daily lives. Also, when it is used as a seasoning, it is not only a mere substitute for the fermented soybean paste, but can impart a novel taste and flavor because it exhibits richness and thickness which is not found in conventional products.

The above written description of the invention provides a manner and process of making and using it such that any person skilled in this art is enabled to make and use the same, this enablement being provided in particular for the subject matter of the appended claims, which make up a part of the original description.

As used herein, the phrases “selected from the group consisting of,” “chosen from,” and the like include mixtures of the specified materials.

Where a numerical limit or range is stated herein, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

Having generally described this invention, a further understanding can be obtained by reference to certain specific examples, which are provided herein for purposes of illustration only, and are not intended to be limiting unless otherwise specified.

### EXAMPLES

### Example 1

### Cheese-like Wet Type Food 1

50 kg of soybean was soaked in water to allow water absorption, followed by steam-cooking at 114° C. for 40 minutes in a steam cooker. The steam-cooked soybean was placed into an airtight type koji making machine, and mixed further with 1 kg of a culture broth of L. lactis AJ110212 (FERM BP-8552) (nisin activity: 4500 IU/ml) and 0.05 kg of a koji mold starter (“Koji mold starter for fermented soybean paste” manufactured by Bioc). Subsequently the mixture was subjected to koji making at 30° C. for 43 hrs. Air sterilized by passing through a HEPA filter was used to remove the heat generated upon fermentation during the koji making.

While koji was made in the koji-making machine while maintaining the inner part of the machine free from outside air except for the time period of “TEIRE”-treatment. The “TEIRE” treatment was performed for 15 minutes every 10 hours after the initiation of koji making and entails introduction of outside air into the inner part of the koji-making machine. To the resulting koji was added 37 kg of a culture broth of L. lactis AJ110212 (FERM BP-8552) (nisin activity: 4500 IU/ml). After mixing, the mixture was ground with a chopper to form a paste form. This paste was packed in a laminated pouch at an amount of 500 g per one pack. Subsequently, the unrefined soy of fermented soybean paste was hydrolyzed by incubating the pouch at 30° C. for 7 days, and a fermented soybean paste-like food material was obtained by heating at 80° C. for 40 minutes.

To 34 parts by weight of the fermented soybean paste-like food material 28 parts by weight of powdered soybean milk (manufactured by Forestlee Corporation, trade name: MU-TENKA TONYUU POWDER (additive-free soybean milk powder)) and 2 parts by weight of sodium chloride were added. The materials were mixed to homogeneity in a mortar, followed by addition of 16 parts by weight of water and 20 parts by weight of shortening (manufactured by Snow Brand Milk Products Co., Ltd., trade name: Shortening) and the resultant materials were mixed. The mixture was placed in a container, and heat treated in a hot water bath at 85° C. for 40 minutes followed by cooling to obtain a cheese-like food.

Because the cheese-like food exhibited a rich taste, it could be eaten in this state or could be eaten together with bread, cracker or the like. Sensory evaluation was conducted by using a sensory evaluation panel consisting of 10 experts. As a control, a similar food was prepared with replacement of the fermented soybean paste-like food material with an equal amount of a commercially available traditional fermented soybean paste. The results of evaluation are shown in Table 1.

TABLE 1

| | Fermented | |
|---|---|---|
| | soybean | |
| Evaluation standard | paste-like food | Control |
| Smell . Flavor | 4 | 6 |
| Sweetness preference | 5 | 5 |
| Saltiness preference | 10 | 0 (sharp saltiness) |
| Bitterness preference | 3 | 7 |
| Umami preference | 9 | 1 |
| Overall | 8 | 2 |

The numerical values in Table 1 represent numbers of the expert who chose the sample as being more preferable. The product prepared using the fermented soybean paste-like food material of the invention was preferred in the overall evaluation.

### Example 2

### Cheese-like Wet Type Food 2

To 14 parts by weight of the fermented soybean paste-like food material prepared according to the method described in Example 1 were added 30 parts by weight of powdered soybean milk (manufactured by Forestlee Corporation, trade name: Mu-TENKA TONYUU POWDER), 1.5 parts by weight of a salt and 4.5 parts by weight of sugar. The materials were mixed to homogeneity and 19 parts by weight of shortening (manufactured by Snow Brand Milk Products Co., Ltd., trade name: Shortening) and 31 parts by weight of water were added thereto followed by mixing. Thereafter, the mixture was heat treated in a hot water bath at 85° C. for 40 minutes followed by cooling to obtain a cheese-like food.

Because the cheese-like food exhibited a rich taste, it could be eaten in this state or could be eaten together with bread, cracker or the like. Sensory evaluation was conducted by using a sensory evaluation panel consisting of 10 experts. As a control, a similar food was prepared with replacement of the fermented soybean paste-like food material with an equal amount of a commercially available traditional fermented soybean paste. The results of evaluation are shown in Table 2.

TABLE 2

| | Fermented | |
|---|---|---|
| | soybean | |
| Evaluation standard | paste-like food | Control |
| Smell . Flavor | 5 | 5 |
| Sweetness preference | 5 | 5 |
| Saltiness preference | 10 | 0 (sharp saltiness) |
| Bitterness preference | 3 | 7 |
| Umami preference | 10 | 0 |
| Overall | 9 | 1 |

The numerical values in Table 2 represent numbers of the expert who chose the sample as being more preferable. The product prepared using the fermented soybean paste-like food material of the invention was preferred in the overall evaluation.

### Example 3

### Sea Urchin-like Wet Type Food

To 28 parts by weight of the fermented soybean paste-like food material prepared according to the method described in Example 1 were added 12 parts by weight of shortening (manufactured by Snow Brand Milk Products Co., Ltd., trade name: Shortening), 2 parts by weight of sodium chloride, 5.5 parts by weight of soy sauce (manufactured by YAMASA CORPORATION, trade name: Shoyu), 0.5 parts by weight of seaweed tea (manufactured by Gyokuroen Shokuhin Kogyo K.K., trade name: Konbu tya), and 7 parts by weight of fresh cream (manufactured by Morinaga Milk Industry Co., Ltd., trade name: Morinaga Cake whip), and mixed in a mortar. Thereto 2 parts by weight powdered gelatin (manufactured by Maruha Corporation, trade name: Jellice) dissolved in 14 parts by weight of water was added followed by mixing, and then 30 parts by weight of egg yolk heated at 70° C. for 20 minutes were added followed by stirring to homogeneity. Thereafter, the mixture was poured into a mold followed by cooling to obtain a sea urchin-like food.

This product exhibited the texture and taste like sea urchin. For this sea urchin-like food, sensory evaluation was conducted by using a sensory evaluation panel consisting of 10 experts. As a control, a similar food was prepared with replacement of the fermented soybean paste-like food material with an equal amount of a commercially available traditional fermented soybean paste. The results of evaluation are shown in Table 3.

TABLE 3

| | Fermented | |
|---|---|---|
| | soybean | |
| Evaluation standard | paste-like food | Control |
| Smell . Flavor | 5 | 5 |
| Sweetness preference | 4 | 6 |
| Saltiness preference | 9 | 1 |
| Bitterness preference | 4 | 6 |
| Umami preference | 8 | 2 |
| Overall | 8 | 2 |

The numerical values in Table 3 represent numbers of the expert who chose the sample as being more preferable. The product prepared using the fermented soybean paste-like food material of the invention was preferred in the overall evaluation.

### Example 4

### Foie Gras-like Wet Type Food

To 36 parts by weight of the fermented soybean paste-like food material prepared according to the method described in Example 1 were added 23.5 parts by weight of shortening (manufactured by Snow Brand Milk Products Co., Ltd., trade name: Shortening), 1.5 parts by weight of sodium chloride, 7 parts by weight of strong soy sauce (manufactured by YAMASA CORPORATION, trade name: Shoyu) and 9 parts by weight of fresh cream (manufactured by Morinaga Milk Industry Co., Ltd., trade name: Morinaga Cake whip), and mixed in a mortar. Thereto was added 4 parts by weight powdered gelatin (manufactured by Maruha Corporation, trade name: Jellice) dissolved in 18 parts by weight of water followed by mixing to be homogenous. Thereafter, the mixture was poured into a mold followed by cooling to obtain a foie gras-like food.

This product exhibited the texture and taste like foie gras. For this foie gras-like food, sensory evaluation was conducted by using a sensory evaluation panel consisting of 10 experts. As a control, a similar food was prepared with replacement of the fermented soybean paste-like food material with an equal amount of a commercially available traditional fermented soybean paste. The results of evaluation are shown in Table 4.

TABLE 4

| | Fermented | |
|---|---|---|
| | soybean | |
| Evaluation standard | paste-like food | Control |
| Smell . Flavor | 4 | 6 |
| Sweetness preference | 5 | 5 |
| Saltiness preference | 9 | 1 |
| Bitterness preference | 5 | 5 |
| Umami preference | 9 | 1 |
| Overall | 9 | 1 |

The numerical values in Table 4 represent numbers of the expert who chose the sample as being more preferable. The product prepared using the fermented soybean paste-like food material of the invention was preferred in the overall evaluation.

### Example 5

### Bean Curd (Tofu)-like Wet Type Food

To 87 parts by weight of soybean milk (manufactured by TAISHI-FOOD CO., Ltd., trade name: Tonyuu) was added 13 parts by weight of the fermented soybean paste-like food material prepared according to the method described in Example 1, and mixed in a mortar to be homogenous. Thereto was added 0.5 parts by weight of a 1.5% aqueous solution of transglutaminase (manufactured by Ajinomoto Co., Inc., trade name: Activa TG, 1000 units/g) followed by mixing. Thereafter, the mixture was put in a container to allow a reaction of transglutaminase in a hot water bath at 40° C. for 60 minutes. Next, the mixture was subjected to enzyme deactivation in a hot water bath at 85° C. for 40 minutes followed by cooling to obtain a bean curd-like food.

For this bean curd-like food, sensory evaluation was conducted by using a sensory evaluation panel consisting of 10 experts. As a control, a similar food was prepared with replacement of the fermented soybean paste-like food material with an equal amount of a commercially available traditional fermented soybean paste. The results of evaluation are shown in Table 5.

TABLE 5

| | Fermented soybean | |
|---|---|---|
| | paste-like | |
| Evaluation standard | food | Control |
| Smell . Flavor | 5 | 5 |
| Sweetness preference | 5 | 5 |
| Saltiness preference | 9 | 1 |
| Bitterness preference | 2 | 8 |
| Umami preference | 9 | 1 |
| Overall | 9 | 1 |

The numerical values in Table 5 represent numbers of the expert who chose the sample as being more preferable. The product prepared using the fermented soybean paste-like food material of the invention was preferred in the overall evaluation.

### Example 6

### Sesame Bean Curd (Goma Tofu)-like Wet Type Food

To 16 parts by weight of the fermented soybean paste-like food material prepared according to the method described in Example 1 was added 79 parts by weight of a soybean paste (manufactured by Ajipro, sample name: soybean paste) followed by mixing in a mortar to be homogenous. Thereto was added 3 parts by weight of powdered arrowroot (manufactured by MITAKE SYOKUHIN, trade name: Honkuzu) followed by mixing. The mixture was put in a pan, gently heated at 85° C. for 40 minutes while stirring, and poured into a mold followed by cooling to obtain a sesame bean curd-like food.

This product exhibited a rich taste as avocado or ANKIMO (anglerfish liver) does. For this sesame bean curd-like food, sensory evaluation was conducted by using a sensory evaluation panel consisting of 10 experts. As a control, a similar food was prepared with replacement of the fermented soybean paste-like food material with an equal amount of a commercially available traditional fermented soybean paste. The results of evaluation are shown in Table 6.

TABLE 6

| | Fermented | |
|---|---|---|
| | soybean | |
| Evaluation standard | paste-like food | Control |
| Smell . Flavor | 5 | 5 |
| Sweetness preference | 5 | 5 |
| Saltiness preference | 10 | 0 (sharp saltiness) |
| Bitterness preference | 3 | 7 |
| Umami preference | 10 | 0 |
| Overall | 10 | 0 |

The numerical values in Table 6 represent numbers of the expert who chose the sample as being more preferable. The product prepared using the fermented soybean paste-like food material of the invention was preferred in the overall evaluation.

### Example 7

### Soybean Spread-like Wet Type Food

To 24 parts by weight of the fermented soybean paste-like food material prepared according to the method described in Example 1 were added 20 parts by weight of powdered soybean milk (manufactured by Forestlee Corporation, trade name: MU-TENKA TONYUU POWDER), 1 part by weight of sodium chloride and 10 parts by weight of sugar. The materials were mixed in a mortar to be homogenous, and thereto were added 38 parts by weight of water and 8 parts by weight of shortening (manufactured by Snow Brand Milk Products Co., Ltd., trade name: Shortening) followed by mixing. The mixture was put in a container, and subjected to heat treatment in a hot water bath at 85° C. for 30 minutes followed by cooling to obtain a soybean spread-like food.

Because this food exhibited a rich taste, it could be eaten as it is or could be eaten together with bread, cracker or the like. For this soybean spread-like food, sensory evaluation was conducted by using a sensory evaluation panel consisting of 10 experts. As a control, a similar food was prepared with replacement of the fermented soybean paste-like food material with an equal amount of a commercially available traditional fermented soybean paste. The results of evaluation are shown in Table 7.

TABLE 7

| | Fermented | |
|---|---|---|
| | soybean | |
| Evaluation standard | paste-like food | Control |
| Smell . Flavor | 5 | 5 |
| Sweetness preference | 5 | 5 |
| Saltiness preference | 10 | 0 (sharp saltiness) |
| Bitterness preference | 3 | 7 |
| Umami preference | 10 | 0 |
| Overall | 9 | 1 |

The numerical values in Table 7 represent numbers of the expert who chose the sample as being more preferable. The product prepared using the fermented soybean paste-like food material of the invention was preferred in the overall evaluation.

### Example 8

### Bar-shaped Food

To 33 parts by weight of the powdered fermented soybean paste-like food material obtained by freeze-drying of the fermented soybean paste-like food material prepared according to the method described in Example 1 were added 17 parts by weight of powdered soybean, 17 parts by weight of powdered soybean milk (manufactured by Forestlee Corporation, trade name: MU-TENKA TONYUU POWDER) and 1 part by weight of sodium chloride. The materials were mixed in a mortar to be homogenous, and thereto were added 13 parts by weight of shortening (manufactured by Snow Brand Milk Products Co., Ltd., trade name: Shortening) and 20 parts by weight of honey (manufactured by NIHON HACHIMITSU CO., LTD., trade name: Hachi-mitsu) followed by mixing and shaping. Thereafter, the shaped preparation was baked in an oven at 110 to 170° C. for 2 to 10 minutes to give a bar-shaped food.

For this bar-shaped food, sensory evaluation was conducted by using a sensory evaluation panel consisting of 10 experts. As a control, a similar food was prepared with replacement of the fermented soybean paste-like food material with an equal amount of a commercially available traditional fermented soybean paste. The results of evaluation are shown in Table 8.

TABLE 8

| | Fermented | |
|---|---|---|
| | soybean | |
| Evaluation standard | paste-like food | Control |
| Smell . Flavor | 5 | 5 |
| Sweetness preference | 5 | 5 |
| Saltiness preference | 10 | 0 (sharp saltiness) |
| Bitterness preference | 4 | 6 |
| Umami preference | 8 | 2 |
| Overall | 8 | 2 |

The numerical values in Table 8 represent numbers of the expert who chose the sample as being more preferable. The product prepared using the fermented soybean paste-like food material of the invention was preferred in the overall evaluation.

### Example 9

### Cookie 1

27 parts by weight of butter which was kneaded with a wooden dipper were placed in a bowl. Thereafter, 13 parts by weight of sucrose was added and ground with mixing, followed by addition of 5 parts by weight of whole egg. Next, 40 parts by weight of wheat flour and 16 parts by weight of the powdered fermented soybean paste-like food material obtained by freeze-drying of the fermented soybean paste-like food material prepared according to the method described in Example 1 were added thereto. The mixture was then kneaded by hand, maintained for about 30 minutes in the refrigerator followed by shaping, and was then baked in an oven at 170° C. for 10 to 20 minutes to obtain a cookie.

For this cookie, sensory evaluation was conducted by using a sensory evaluation panel consisting of 10 experts. As a control, a similar food was prepared with replacement of the fermented soybean paste-like food material with an equal amount of a commercially available traditional fermented soybean paste. The results of evaluation are shown in Table 9.

TABLE 9

| | Fermented | |
|---|---|---|
| | soybean | |
| Evaluation standard | paste-like food | Control |
| Smell . Flavor | 6 | 4 |
| Sweetness preference | 5 | 5 |
| Saltiness preference | 8 | 2 |
| Bitterness preference | 5 | 5 |
| Umami preference | 8 | 2 |
| Overall | 8 | 2 |

The numerical values in Table 9 represent numbers of the expert who chose the sample as being more preferable. The product prepared using the fermented soybean paste-like food material of the invention was preferred in the overall evaluation.

### Example 10

### Cookie 2

28 parts by weight of butter which was kneaded with a wooden dipper was placed in a bowl. Thereafter, 8 parts by weight of whole egg was added thereto followed by stirring. Subsequently, 51 parts by weight of dumpling mix (manufactured by MITAKE SYOKUHIN, trade name: Mitake Danngo-no Kona), 4 parts by weight of powdered bonito stock (manufactured by Ajinomoto Co., Inc., sample name: Honzukuri Ichiban Dashi Kiwami Katsuo Hunmatsu) and 8 parts by weight of the powdered fermented soybean paste-like food material obtained by freeze-drying of the fermented soybean paste-like food material prepared according to the method described in Example 1 were added thereto. The mixture was then kneaded by hand, maintained for about 30 minutes in the refrigerator followed by shaping, and was then baked in an oven at 170° C. for 10 to 20 minutes to obtain a cookie.

For this cookie, sensory evaluation was conducted by using a sensory evaluation panel consisting of 10 experts. As a control, a similar food was prepared with replacement of the fermented soybean paste-like food material with an equal amount of a commercially available traditional fermented soybean paste. The results of evaluation are shown in Table 10.

TABLE 10

| | Fermented | |
|---|---|---|
| | soybean | |
| Evaluation standard | paste-like food | Control |
| Smell . Flavor | 6 | 4 |
| Sweetness preference | 6 | 4 |
| Saltiness preference | 7 | 3 |
| Bitterness preference | 5 | 5 |
| Umami preference | 9 | 1 |
| Overall | 8 | 2 |

The numerical values in Table 10 represent numbers of the expert who chose the sample as being more preferable. The product prepared using the fermented soybean paste-like food material of the invention was preferred in the overall evaluation.

### Example 11

### Chicken Consomme

To 24 parts by weight of chicken consomme (manufactured by Ajinomoto Co., Inc., 1 kg can), 1000 parts by weight of boiling water and 0.5 parts by weight of the fermented soybean paste-like food material prepared according to the method described in Example 1 were added ,and the resulting solution was boiled. As a consequence of evaluating thus resulting chicken consomme, stronger meaty thickness, continuing umami taste were exhibited in comparison with one to which no fermented soybean paste-like food material was added.

### Example 12

### Hot-pot

750 parts by weight of water were placed in a pot followed by boiling to which 72 parts by weight of the fermented soybean paste-like food material prepared according to the method described in Example 1, 6.5 parts by weight of sodium chloride and 36 parts by weight of Japanese sweet rice wine for cooking (manufactured Takara Shuzo Co., Ltd., trade name: Takara hon-mirin) were added. The pot was put over a fire, and after boiling, 225 parts by weight of sliced pork loin with a width of 5 cm, 225 parts by weight of radish and 75 parts by weight of carrot cut into semi-circular slices or ginkgo leaf-shaped slices having a thickness of 3 to 5 mm were added thereto followed by additional boiling on medium to low heat while skimming off the scum. Five minutes later, 50 parts by weight of scallop, 115 parts by weight of bean sprout and 225 parts by weight of cabbage cut into bite-size were added thereto, and boiled. After a lapse of 25 minutes, 75 parts by weight of green Chinese chives cut into pieces having a width of 5 cm were added thereto. After boiling the entirety, the heating was stopped.

For this cooked food, sensory evaluation was conducted by using a sensory evaluation panel consisting of 10 experts. As a control, a similar food was prepared with replacement of the fermented soybean paste-like food material with an equal amount of a commercially available traditional fermented soybean paste. However, the fermented soybean paste used in the control contained an equal amount of sodium chloride to that added to this cooked food, therefore, no sodium chloride was added to the control. The results of evaluation are shown in Table 11.

TABLE 11

| | Fermented soybean | |
|---|---|---|
| Evaluation standard | paste-like food | Control |
| Smell · Flavor | 4 | 6 |
| Sweetness preference | 5 | 5 |
| Saltiness preference | 8 | 2 |
| Bitterness preference | 4 | 6 |
| Umami preference | 7 | 3 |
| Overall | 7 | 3 |

The numerical values in Table 11 represent numbers of the expert who chose the sample. The present cooked food had a more thickness and richness than the control, and a stronger bean flavor was perceived. Further, darker color and stronger titer of the taste were exhibited, and the taste was soaked into the vegetable materials.

### Example 13

### Stir-fried Meat and Vegetables

A frying pan was placed over a fire, and 50 parts by weight of pork loin slices with a width of 5 cm were stir-fried briefly therein. Thereafter, 200 parts by weight of a vegetable mix was added thereto. After stir-frying until the materials become soften, heating was stopped, and thereto were added 21 parts by weight of the fermented soybean paste-like food material prepared according to the method described in Example 1 and 2.5 parts by weight of sodium chloride and well-mixed. The frying pan was again put over a fire and the entirety was heated.

For this cooked food, sensory evaluation was conducted by using a sensory evaluation panel consisting of 10 experts. As a control, a similar food was prepared with replacement of the fermented soybean paste-like food material with an equal amount of a commercially available traditional fermented soybean paste. However, the fermented soybean paste used in the control contained an equal amount of sodium chloride to that added to this cooked food, therefore, no sodium chloride was added to the control. The results of evaluation are shown in Table 12.

TABLE 12

| | Fermented soybean | |
|---|---|---|
| Evaluation standard | paste-like food | Control |
| Smell · Flavor | 6 | 4 |
| Saltiness preference | 5 | 5 |
| Bitterness preference | 4 | 6 |
| Umami preference | 8 | 2 |
| Overall | 7 | 3 |

The numerical values in Table 12 represent numbers of the expert who chose the sample. The product prepared using the fermented soybean paste-like food material of the invention was preferred in the overall evaluation.

### Example 14

### Sauce for Chinese Dishes

To a sauce for a Chinese dish “Stir-fried pork and cabbage (manufactured by Ajinomoto Co., Inc., trade name: Cook Do HOIKORO) was added 1 part by weight or 5 parts by weight of the fermented soybean paste-like food material prepared according to the method described in Example 1, and cooked foods were prepared according to the direction on the product package.

For these cooked foods, sensory evaluation was conducted by using a sensory evaluation panel consisting of 10 experts. The results of evaluation are shown in Table 13.

TABLE 13

| | Fermented | Fermented | |
|---|---|---|---|
| | soybean | soybean | Fermented |
| | paste-like food | paste-like food | soybean |
| | 1 part by | 5 parts by | paste-like food |
| Evaluation standard | weight added | weight added | not added |
| Smell · Flavor | 6 | 3 | 1 |
| Sweetness preference | 5 | 1 | 4 |
| Saltiness preference | 4 | 2 | 4 |
| Bitterness preference | 3 | 1 | 6 |
| Umami preference | 7 | 2 | 1 |
| Overall | 8 | 1 | 1 |

The numerical values in Table 13 represent numbers of the expert who chose the sample. When no fermented soybean paste-like food material was added, a savory flavor was exhibited resulting from the soy sauce, fermented soybean paste and meat, with strong umami taste and richness. However, when the material was added in an amount of 1 part by weight, the flavor was on an equal level to the control, but the richness increased to some extent. Moreover, when the material was added in an amount of 5 parts by weight, the flavor was on an equal level to the control, but the richness remained in aftertaste while also the tightness (vivid taste) was imparted.

### Example 15

### Seasoning for Fried Chicken

To 5 parts by weight of the powdered fermented soybean paste-like food material obtained by freeze-drying of the fermented soybean paste-like food material prepared according to the method described in Example 1 were added 40.5 parts by weight of weak flour, 37.5 parts by weight of corn starch, 4 parts by weight of flavor enhancer (manufactured by Ajinomoto Co., Inc., trade name: “Ajinomoto”), 10 parts by weight of sodium chloride, 0.5 parts by weight of pepper, 1.0 part by weight of onion powder and 1.5 parts by weight of garlic powder. The materials were mixed well to be a seasoning powder. To 90 parts by weight of chicken meat was added 10 parts by weight of the seasoning powder. After putting them into a reclosable plastic bag with zip to mix both ingredients well, the meat was oil-fried in oil at 170° C. for 3 minutes.

For this fried chicken, sensory evaluation was conducted by using a sensory evaluation panel consisting of 10 experts. As a control, a similar food prepared through replacing the powdered fermented soybean paste-like food material with a powdered soy sauce in an equal amount was used. This fried chicken exhibited a stronger umami taste than the control, and the texture of meats was better.

### Example 16

### Dressing

To 18 parts by weight of the fermented soybean paste-like food material prepared according to the method described in Example 1 was added 53 parts by weight of water, and mixed in a mortar to be homogenous. Thereto were added 3 parts by weight of sodium chloride, 18 parts by weight of vinegar (manufactured by Mizkan Co., Ltd., trade name: Okome de Tsukutta Jyun-na Osu), 2 parts by weight of soy sauce (manufactured by YAMASA CORPORATION, trade name: Shoyu), 1 part by weight of honey (manufactured by NIHON HACHIMITSU CO., LTD., trade name: Hachi-mitsu) and 5 parts by weight of a bonito and seaweed stock (manufactured by Ajinomoto Co., Inc., trade name: Honzukuri Ichiban Dashi Kiwami Katsuo Konbu). The materials were mixed to be homogenous thereby obtaining a dressing.

For this dressing, sensory evaluation was conducted by using a sensory evaluation panel consisting of 10 experts. As a control, a similar dressing prepared through replacing the fermented soybean paste-like food material with a commercially available traditional fermented soybean paste in an equal amount was used. Although the control exhibited sharp saltiness, the present dressing exhibited no sharp saltiness and was preferred.

### Example 17

### Soy Sauce

To a light colored soy sauce and a soy sauce was added each 1, 5 or 10 parts by weight of the fermented soybean paste-like food material prepared according to the method described in Example 1, respectively. When the material was added to the light colored soy sauce, the addition of 1 part by weight strengthened the sweetness and umami taste and made the overall tastewell-balanced. When it was added in an amount of 5 parts by weight, the flavor of the fermented soybean paste-like food material became so strong thereby making the soy sauce like having the flavor of a fermented soybean paste. When it was added in an amount of 10 parts by weight, the flavor of the fermented soybean paste-like food material was extremely strong and the soy sauce flavor was lost. When the material was added to the soy sauce, the sauce with 1 part by weight of the material exhibited spread taste, while the addition of 5 parts by weight resulted in rounding the sharp soy sauce flavor and improvement of the entire taste strength. When it was added in an amount of 10 parts by weight, the flavor of the fermented soybean paste-like food material was extremely strong, and a weak flavor of the soy sauce was exhibited.

From these results it was revealed that this material is preferably added in an amount of 1 part by weight to light colored soy sauce, and 5 parts by weight to soy sauce.

### Example 18

### Dipping Sauce

To 52 parts by weight of the fermented soybean paste-like food material prepared according to the method described in Example 1 was added 2.5 parts by weight of sodium chloride, and mixed in a mortar to be homogenous. Thereto were added 3 parts by weight of vinegar (manufactured by Mizkan Co., Ltd., trade name: Okome de Tsukutta Jyun-na Osu), 6 parts by weight of soy sauce (manufactured by YAMASA CORPORATION, trade name: Shoyu), 11 parts by weight of honey (manufactured by NIHON HACHIMITSU CO., LTD., trade name: Hachi-mitsu) and 16 parts by weight of bonito and seaweed stock (manufactured by Ajinomoto Co., Inc., trade name: Honzukuri Ichiban Dashi Kiwami Katsuo Konbu). The materials were further mixed, and thereto was gradually added 10 parts by weight of a soybean oil and mixed to be homogenous thereby obtaining a dipping sauce.

For the resulting dip solution, sensory evaluation was conducted by using a sensory evaluation panel consisting of 10 experts. As a control, a similar food was prepared with replacement of the fermented soybean paste-like food material with an equal amount of a commercially available traditional fermented soybean paste. The results of evaluation are shown in Table 14.

TABLE 14

| | Fermented soybean | |
|---|---|---|
| Evaluation standard | paste-like food | Control |
| Smell · Flavor | 4 | 6 |
| Sweetness preference | 9 | 1 |
| Saltiness preference | 10 | 0 |
| | | (sharp saltiness) |
| Sourness preference | 9 | 1 |
| | | (sharp vinegar flavor) |
| Bitterness preference | 6 | 4 |
| Umami preference | 9 | 1 |
| Overall | 9 | 1 |

The numerical values in Table 14 represent numbers of the expert who chose the sample. The food prepared using the fermented soybean paste-like food material of the invention was preferred in overall evaluation.

### Example 19

### Dipping Sauce for Noodles

To 80 parts by weight of soy sauce (manufactured by Higeta Shoyu Co. Ltd., trade name: Honzen) were added 8 parts by weight of Japanese sweet rice wine for cooking (manufactured Takara Shuzo Co., Ltd., trade name: Takara hon-mirin) and 12 parts by weight of sugar, and mixed. After heating in a hot water bath at 80° C. for 30 minutes, the solution was cooled. To 15 parts by weight of the solution (“kaeshi”) was added 83 parts by weight of 10-times dilution of bonito and seaweed stock (manufactured by Ajinomoto Co., Inc., trade name: Honzukuri Ichiban Dashi Kiwami Katsuo Konbu), and mixed well to obtain a dipping sauce for noodles. To this dipping sauce for noodles was added 10 to 20 parts by weight of the fermented soybean paste-like food material prepared according to the method described in Example 1, and mixed well.

For the resulting dipping sauce for noodles, sensory evaluation was conducted by using a sensory evaluation panel consisting of 10 experts. As a control, a similar food prepared without adding the fermented soybean paste-like food material was used. The dipping sauce for noodles to which the fermented soybean paste-like food material was added was a mild dipping sauce for noodles exhibiting extreme richness compared to the control in any of the amount of addition.

### Example 20

### White Sauce

To 100 parts by weight of a commercially available white sauce (manufactured by Ajinomoto Co., Inc., White sauce for foodservice use, 10 kg, product packed in a box) was added 1000 parts by weight of milk while heating and stirring. Further, therein was dissolved 0.45 parts by weight of the fermented soybean paste-like food material prepared according to the method described in Example 1 followed by boiling for 3 minutes. As a consequence of evaluating thus resulting white sauce, it exhibited more thickness, umami taste and rich creamy flavor compared to the white sauce prepared without adding the fermented soybean paste-like food material.

### Example 21

### Demiglace Sauce

To 122 parts by weight of a commercially available demiglace sauce (manufactured by Ajinomoto Co., Inc., demiglace sauce for foodservice use, 10 kg, product packed in a box) was added 1000 parts by weight of hot water while heating and stirring. Further, therein was dissolved 0.45 parts by weight of the fermented soybean paste-like food material prepared according to the method described in Example 1 followed by boiling for 5 minutes. As a consequence of evaluating thus resulting demiglace sauce, it exhibited more meaty thickness with a butter flavor and more stewed flavor, in comparison with the demiglace sauce prepared without adding the fermented soybean paste-like food material.

### Example 22

### Tomato Sauce

In 100 parts by weight of a commercially available tomato sauce (manufactured by Ajinomoto Co., Inc., pronto tomato sauce for foodservice use, 2 kg, canned product) was dissolved 0.05 parts by weight of the fermented soybean paste-like food material prepared according to the method described in Example 1 followed by mixing. As a consequence of evaluating thus resulting tomato sauce, richness and more stewed flavor were exhibited while sharp sourness turned to be milder, in comparison with the tomato sauce prepared without adding the fermented soybean paste-like food material.

### Example 23

### Curry Roux

To 100 parts by weight of a commercially available curry roux (manufactured by House Foods Corporation) was added 0.5 parts by weight of the fermented soybean paste-like food material prepared according to the method described in Example 1. As a consequence of evaluating thus resulting curry roux, more stewed flavor and aged flavor were exhibited while spice flavors remained, in comparison with the curry roux prepared without adding the fermented soybean paste-like food material.

### Example 24

### Soybean Milk Beverage

To 5 parts by weight of the fermented soybean paste-like food material prepared according to the method described in Example 1 were added 6 parts by weight of honey (manufactured by NIHON HACHIMITSU CO., LTD., trade name: Hachi-mitsu), 85 parts by weight of soybean milk and 4 parts by weight of lemon juice. As a result of mixing the ingredients in a mixer, a beverage exhibiting a favorable taste and flavor was obtained.

### Example 25

### Japanese Confectionery, Miso Matsu-kaze)

To 26.5 parts by weight of purified sugar, 23.6 parts by weight of weak flour and 0.4 parts by weight of baking powder were added 20 parts by weight of water, 6.6 parts by weight of fermented soybean paste (shiro miso) and 0.4 parts by weight of the fermented soybean paste-like food material prepared according to the method described in Example 1, and mixed. Thereafter, 9.6 parts by weigh of whipped egg white and 12.5 parts by weight of Dainagon (a kind of adzuki bean) were further added thereto. The mixture was poured into a mold, and heated in a steamer to prepare a Japanese confectionery.

For this Japanese confectionery, sensory evaluation was conducted by using a sensory evaluation panel consisting of 10 experts. As a control, a similar one prepared without using the fermented soybean paste-like food material was used. The results of evaluation are shown in Table 15.

TABLE 15

| | Experimental group | |
|---|---|---|
| | Fermented soybean | Fermented soybean |
| | paste-like food added | paste-like food not added |
| Choice | 10 | 0 |
| comment | Complex flavor and savor. | Flavor of steamed wheat flour. |
| | Sweetness, umami taste | Smooth sweetness predominant. |
| | strengthened. Richness | |
| | imparted. | |

The numerical values in Table 15 represent numbers of the expert who chose the sample. The product prepared using the fermented soybean paste-like food material of the invention was preferred in the overall evaluation.

### Example 26

### Ice Cream

To 57.6 parts by weight of milk was added the fermented soybean paste-like food material prepared according to the method described in Example 1 in an amount of 0.1 parts by weight, 0.5 parts by weight, 1 part by weight and 3 parts by weight, respectively, and heated. In another bowl were put 12.9 parts by weight of egg yolk and 13.4 parts by weight of sugar, and mixed until the mixture turned white. Thereto was added the aforementioned milk, and heated in a pan till thickened. Then, thereto was added 16.1 parts by weight of fresh cream, and mixed in an ice cream maker. The mixture was poured into a mold, and hardened by freezing in a freezer.

For thus resulting ice cream, sensory evaluation was conducted by using a sensory evaluation panel consisting of 10 experts. As a control, a similar one prepared without using the fermented soybean paste-like food material was used. The results are shown in Table 16.

TABLE 16

| | Experimental group | | | |
|---|---|---|---|---|
| | Fermented soybean | Fermented | Fermented soybean | Fermented |
| | paste-like food | soybean paste- | paste-like food | soybean paste- |
| | 0.5 parts by | like food | 3 parts by | like food |
| | weight | 1 part by weight | weight | not added |
| Sensory | Slightly rich | Thick richness | Slightly harsh taste | Mild flavor of |
| comment | deliciousness | imparted being | appeared being | milk and rich |
| | imparted | favorable | unpreferred | sweetness |
| | | | | present |

As shown in Table 16, the amount of the added fermented soybean paste-like food material was particularly preferably 1 part by weight.

### Example 27

### Miso Soup-like Food

50 kg of soybean was soaked in water to allow water absorption, followed by steam- cooking at 114° C. for 40 minutes in a steam cooker. The steam-cooked soybean was placed into an airtight type koji making machine, and further mixed with 1 kg of a culture broth of L. lactis AJ110212 (FERM BP-8552) (nisin activity: 2900 IU/ml) and 0.05 kg of a koji mold starter (“Koji mold starter for fermented soybean paste” manufactured by Bioc). Subsequently the mixture was subjected to koji making at 30° C. for 43 hrs. Air sterilized by passing through a HEPA filter was used to remove the heat generated upon fermentation during the koji making.

While koji was made in the koji-making machine while maintaining the inner part of the machine free from outside air except for the time period of “TEIRE”-treatment (a step of stirring the mixture in the koji making machine for the purpose of accelerating the growth of the Koji mold). The “TEIRE”-treatment was performed for 15 minutes every 10 hours after initiation of the koji making. To the resulting solid koji was added 14.6 kg of a culture broth of L. lactis AJ110212 (FERM BP-8552) (nisin activity: 2800 IU/ml) and 34.7 kg of steam-cooked rice. After mixing, the mixture was ground with a chopper to form a paste form. This paste was packed in a laminated pouch at an amount of 1 kg per one pack.

The unrefined soy of fermented soybean paste was hydrolyzed by incubating the stuffed pouch at 30° C. for 7 days, and a fermented soybean paste-like food material was obtained by heating at 85° C. for 40 minutes. To 30 parts by weight of this fermented soybean paste-like food material 6 parts by weight of bonito soup stock (manufactured by Ajinomoto Co. Inc., trade name: MARUGOTO KATSUODASHI), 174 parts by weight of hot water and proper amounts of tofu and fried tofu were added and a miso soup-like food was prepared. The miso soup-like food exhibited strong umami taste and richiness but weak saltiness and it was confirmed that the food is a novel food different from a traditional miso soup. Since the miso soup-like food contains almost no salt and a fermented miso paste part in an amount of three times by weight of that in a traditional miso soup can be added and the health value of soybean can be easily taken more.

### Example 28

### Potage Soup-like Food

To 140 parts by weight of the fermented soybean paste-like food material prepared according to the method described in Example 27 were added 28 parts by weight of potato powder, 5.6 parts by weight of garlic powder, 0.3 parts by weight of onion powder, 10.2 parts by weight of potato starch, 4.2 parts by weight of salt, 42 pars by weight of liquid bonito soup stock, 3.5 parts by weight of honey, 490 parts by weight of soy milk, 380 parts by weight of hot water and proper amounts of spices such as pepper and ginger and milk, and a potage soup-like food was obtained. The food exhibited different flavor and taste from traditional potage soup, however, it was a soup exhibiting strong umami taste and richiness but weak saltiness.

### Example 29

### Soybean Spread “SOBORO”

To 38 parts by weight of the fermented soybean paste-like food material prepared according to the method described in Example 27 were added 33 parts by weight of chopped fried soybean, 6 parts by weight of soy sauce and 23 parts by weight of other food material such as soybean oil and powdered bonito stock. The mixture was mixed in a bowl and vacuum packed in an aluminum pouch such that 50 g was filled in one pack. The packed mixture was heat-sterilized for 15 minutes in boiling water and a soybean spread-like food was prepared. The food exhibited strong umami taste, thichness in after-taste and richness derived from the fermented soybean paste-like food material. It was confirmed that it can be eaten as it is and eaten with rice as substitute for chicken SOBORO, NATTO (fermented soybean) or FURIKAKE (seasoned powder sprinkled over rice). In addition, it was confirmed that it can be used as a topping or an ingredient for vegetables, tofu (bean curds), omelets or bread. The food can provide a way to take the health value of soybean tastily and easily in daily diets.

In view of the foregoing and because the novel food obtained according to the method of the present invention is delicious, functional ingredients for health of the fermented soybean paste such as isoflavone and saponin in a large quantity can be readily ingested in daily lives. Also, when it is used as a seasoning, it is not only a mere substitute for the fermented soybean paste, but can impart a novel taste and flavor because it exhibits richness and thickness not found in conventional products. Accordingly, the invention is extremely advantageous in industry, particularly in a food industry.

Numerous modifications and variations on the present invention are possible in light of the above teachings. It is, therefore, to be understood that within the scope of the accompanying claims, the invention may be practiced otherwise than as specifically described herein.

1. A method for producing a food product comprising
mixing a fermented soybean paste-like food material with a food material other than said fermented soybean paste-like food material, wherein said fermented soybean paste-like food material is produced by a process comprising
making solid koji from a raw plant material and koji mold,
making un unrefined soy by adding steam-cooked or roasted raw plant material to said solid koji, and
hydrolyzing said unrefined soy in the absence of sodium chloride or gluconic acid salt for a bacteriostatic purpose.

2. The method according to claim 1, wherein said raw plant material comprises at least one grain selected from the group consisting of soybean, rice, and wheat.

3. The method according to claim 1, wherein said making solid koji is in the presence of a culture broth of a bacteriocin producing lactic acid bacterium or a supernatant thereof.

4. The method according to claim 3, wherein said bacteriocin is nisin.

5. The method according to claim 1, wherein said hydrolyzing said unrefined soy is in the presence of a culture broth of a bacteriocin producing lactic acid bacterium or a supernatant thereof.

6. The method according to claim 5, wherein said bacteriocin is nisin.

7. The method according to claim 1, wherein said making solid koji is in an aseptic and airtight container.

8. The method according to claim 1, wherein said hydrolyzing said unrefined soy is in an aseptic and airtight container.

9. The method according to claim 1, wherein said fermented soybean paste-like food material is obtained by
(1) adding koji mold and a culture broth of a bacteriocin producing lactic acid bacterium or a supernatant thereof to a raw plant material comprising at least one grain selected from the group consisting of soybean, rice and wheat,
(2) making koji in a koji-making machine in which the outside air is excluded for a time period of “TEIRE”-treatment, while supplying sterilized air continuously or intermittently,
(3) mixing the resultant koji with a culture broth of a bacteriocin producing lactic acid bacterium or a supernatant thereof, and further mixing with a previously steam-cooked or roasted composition comprising at least one grain selected from the group consisting of soybean, rice, and wheat in an amount of 0.01 to 50 times by weight of the resulting koji,
(4) forming an unrefined soy by making the paste form of the mixture,
(5) and hydrolyzing the unrefined soy essentially in the absence of sodium chloride.

10. The method according to claim 9, wherein said essentially in the absence of sodium chloride is less than 5% by weight sodium chloride.

11. The method according to claim 1, wherein said food is selected from the group consisting of a seasoning, a soup, a retorted food, and a confectionery.

12. The method according to claim 11, wherein said food is a seasoning and said seasoning is selected from the group consisting of a chili seasoning, a soy sauce, a stock, a sauce, a tomato product, a dressing, and a roux.

13. A food obtained by the method according to claim 1.

14. A production method for a processed food comprising shaping the food obtained by the method according to claim 1.

15. The method according to claim 14, wherein said processed food is selected from the group consisting of a bar-shaped food, a solid roux type food, a baked confectionery, and a wet type food containing 10 to 95% by weight of moisture.

16. The method according to claim 14, wherein said shaping is achieved by an enzymatic process.

17. The method according to claim 14, wherein said shaping is achieved by baking.

18. The method according to claim 14, wherein said shaping is by heating and cooling with fat or oil.

19. The method according to claim 14, wherein said shaping is by heating and cooling with a gelatin or a polysaccharide, or a mixture thereof.

20. A food obtained by the method according to claim 14.
